(19) United States
(12) Patent Application Publication
(10) Pub. No.: US 2019/0118526 A1
(43) Pub. Date: Apr. 25, 2019

(54) SCREEN PRINTING DEVICE

(71) Applicants: BOE Technology Group Co., Ltd., Beijing (CN); Ordos Yuansheng Optoelectronics Co., Ltd., Ordos (CN)

(72) Inventor: Zhifeng TIAN, Beijing (CN)

(21) Appl. No.: 16/043,659

(22) Filed: Jul. 24, 2018

(30) Foreign Application Priority Data
Oct. 25, 2017 (CN) 201711009951.5

(51) Int. Cl. B41F 15/08; B41F 13/00; B41F 13/004

(52) U.S. Cl. CPC B41F 15/0836; B41F 15/0809; B41P 2215/12; B41F 13/0045; B41F 13/0008

(57) ABSTRACT

The present application discloses a screen printing device, comprising: a transport mechanism, which is used to carry and transport a plate to be printed disposed on the transport mechanism; a rotating frame located above the transport mechanism, which is used for winding a screen and driving the screen rotation; and a glue container located in the rotating frame and disposed to be independent of the rotating frame, wherein a lower portion of the glue container is provided with a glue outlet and a scraper, and the scraper is located beside the glue outlet. Since the screen printing device adopts a rolling printing mode, the tension generated by each position of the screen at the scraper is the same, thereby avoiding the poor printing uniformity due to the tension difference during the printing process.

### CROSS-REFERENCE TO RELATED APPLICATION

This application claims the priority of China Patent Application No. 201711009951.5, filed in China on Oct. 25, 2017, the entire contents of which are hereby incorporated by reference.

### TECHNICAL FIELD

The present application relates to a screen printing device.

### BACKGROUND

Display technology plays a very important role in modern communication technology. With the popularization of digital information products such as mobile phones, digital cameras and laptops, display devices being clear and lightweight have become one of focus issue of concern. Screen printing is also called universal printing, which can be printed on various substrates. The substrates comprise various plastics, textiles, metals, glass, and ceramics, etc. However, the conventional screen printing devices have problems such as poor printing uniformity, encapsulant being volatile and inconsistent printing height.

### SUMMARY

The present disclosure provides a screen printing device, comprising: a transport mechanism, which is used to carry and transport a plate to be printed disposed on the transport mechanism; a rotating frame located above the transport mechanism, which is used for winding a screen and driving the screen rotation; and a glue container located in the rotating frame and disposed to be independent of the rotating frame, wherein a lower portion of the glue container is provided with a glue outlet and a scraper, and the scraper is located beside the glue outlet.

Optionally, the screen printing further comprises: a first driving mechanism coupled to the rotating frame, which is used for driving the rotating frame to rotate; a control system electrically connected to the transport mechanism and the first driving mechanism, wherein, according to a printing parameter of the plate to be printed, a transport speed of the plate to be printed is adjusted by the transport mechanism, and a rotation speed of the rotating frame is adjusted by the first driving mechanism.

Optionally, the screen printing device further comprises: a pressure supply mechanism connected to the glue container, which is used for supplying pressure to the glue container, so as to adjust an amount of glue discharged from the glue outlet; wherein the control system is further electrically connected to the pressure supply mechanism, and the control system is configured to adjust the pressure in the glue container by the pressure supply mechanism according to the printing parameter of the plate to be printed.

Optionally, the screen printing device further comprises: a second driving mechanism, which is independent of the rotating frame, wherein the glue container is mounted on the second driving mechanism, and the second driving mechanism is configured to drive the glue container to move or rotate; wherein the control system is further electrically connected to the second driving mechanism, the control system is configured to adjust a position of the glue container within the rotating frame by the second driving mechanism according to the printing parameter of a plate to be printed, so as to adjust a position of the scraper within the rotating frame.

Optionally, the screen printing device further comprises: a second driving mechanism, which is independent of the rotating frame, wherein the glue container is mounted on the second driving mechanism, and the second driving mechanism is configured to drive the glue container to move and rotate; wherein the control system is further electrically connected to the second driving mechanism, the control system is configured to adjust a position of the glue container within the rotating frame by the second driving mechanism according to the printing parameter of a plate to be printed, so as to adjust a position of the scraper within the rotating frame.

Optionally, the second driving mechanism comprises a moving member and a rotating member, the rotating member is mounted on the moving member, and the glue container is mounted on the rotating member, the moving member is configured to drive the rotating member and the glue container to achieve a six-direction movement, and the rotating member is configured to drive the glue container to rotate.

Optionally, the screen printing device further comprises: a cover plate disposed in the glue container, wherein a periphery of the cover plate is sealingly engaged with an inner side surface of the glue container, and the pressure supplied into the glue container by the pressure supply mechanism acts on an upper surface of cover plate.

Optionally, the screen printing device further comprises: a sealing ring, which is located between the inner side surface of the glue container and the cover plate and, wherein the sealing ring is fixed on the cover plate.

Optionally, an inner cavity of the glue container is a cuboid, and the cover plate has a rectangular plate shape.

Optionally, a rotation direction of the rotating frame is different from a direction of a transport speed of the transport mechanism at a position of the scraper during printing process.

Optionally, the rotating frame comprises two rotating disks which are symmetrically disposed, the screen is disposed between the two rotating disks, a pair of opposite sides of the screen is wound on the two rotating disks, and the first driving mechanism drives the two rotating disks to rotate synchronously.

Optionally, another pair of opposite sides of the screen is aligned to form a cylindrical shape.

Optionally, the control system comprises: a detection module, which is used to detect the transport speed of the transport mechanism and the rotation speed of the rotating frame constantly; and a controller electrically connected to the detection module, which is configured to adjust the transport speed of the transport mechanism according to a transport speed data corresponding to the printing parameter of the plate to be printed, and adjust the rotation speed of the rotating frame according to a rotation speed data corresponding to the printing parameter of the plate to be printed.

Optionally, the controller comprises: a comparison judgment module electrically connected to the detection module, which is used to compare the transport speed being detected with the transport speed data corresponding to the printing parameter of the plate to be printed and send a transport speed failure information if a comparison result is unqualified; and also used to compare the rotation speed being detected with the rotation speed data corresponding to the printing parameter of the plate to be printed and send a rotation speed failure information if the comparison result is unqualified; and an adjustment module electrically connected to the comparison judgment module, which is used to adjust the transport speed of the transport mechanism to a value of the transport speed data when receiving the transport speed failure information, and used to adjust the rotation speed of the rotating frame to a value of the rotation speed data by the first driving mechanism when receiving the rotation speed failure information.

Optionally, the controller further comprises: a control module electrically connected to the comparison judgment module, which is used to control the transport mechanism to keep the transport speed when receiving a transport speed qualification information, and used to control the pressure supply mechanism to keep the pressure when receiving a pressure qualification information, and used to control the first driving mechanism to drive the rotating frame to keep the rotation speed when receiving a rotation speed qualification information.

### BRIEF DESCRIPTION OF THE DRAWINGS

The drawings will enable those skilled in the art to understand the technical solutions of the present disclosure. The drawings constitute a part of the specification, and are used to explain the technical solutions of the present disclosure together with the embodiments of the present application. The drawings do not constitute a limitation on the technical solutions of the present disclosure.

FIG. 1 is a schematic structural view of a related art for screen printing;

FIG. 2 is a schematic structural view of a screen printing device according to an embodiment of the present disclosure;

FIG. 3 is a schematic structural view of a screen depicted in FIG. 2 mounted on a rotating frame; and

FIG. 4 is a block diagram showing the structure of a control system in the screen printing device as shown in FIG. 2.

### DETAILED DESCRIPTION OF THE EMBODIMENTS

In order to make the objects, technical solutions and advantages of the present disclosure clear, the embodiments of the present disclosure will be described in detail below with reference to the accompanying drawings. It should be noted that, in the case of no conflict, the features in the embodiments and the embodiments of the present application may be combined with each other.

In the following description, specific details are set forth in order to provide a complete understanding of the present disclosure, but the present application may be practiced otherwise than the embodiments as described herein. Therefore, the scope of the present application is not limited by the specific embodiments disclosed below. A screen printing device of the related art and a screen printing device in some embodiments of the present disclosure will be described below with reference to the accompanying drawings.

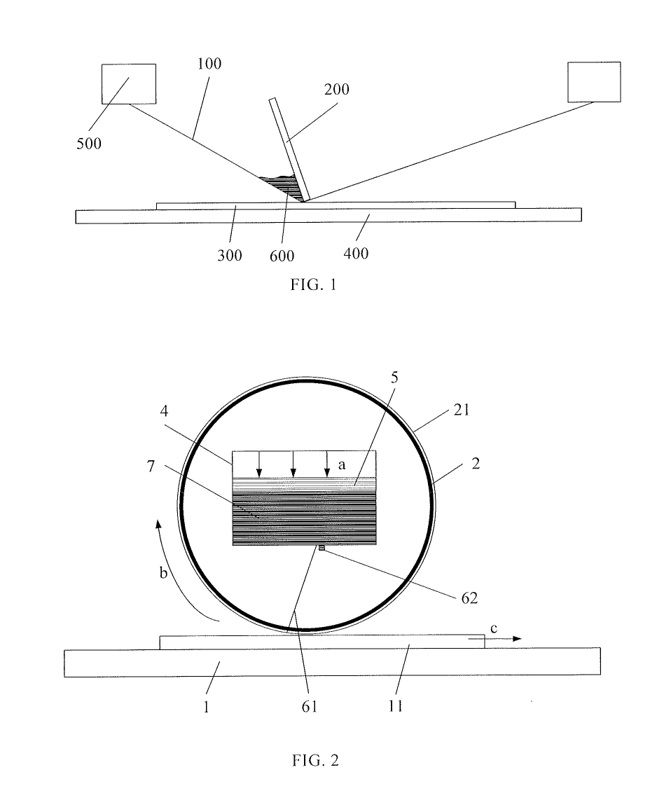

FIG. 1 is a schematic structural view of a related art for screen printing. The screen printing can be used to print the encapsulant to the display device, and the encapsulant is printed by the printing method as shown in the structure of FIG. 1. The printing method is limited by the fixing method of the screen 100. The tension of the screen 100 is different at each position, which causes the encapsulant 600 have a poor printing uniformity during the printing process. Therefore, it is easy to appear a phenomenon that screen is stuck in the screen 100 where tension is small. Moreover, the encapsulant 600 is exposed in the air during printing, and the solvent in the encapsulant 600 may volatilize. The proportion of active ingredient solute in the encapsulant 600 will increase with time, resulting in inconsistent printing height at each position after printing. In addition, the encapsulant 600 is pressed out by the scraper 200 to perform printing. The amount of encapsulant pressed out by the scraper 200 is different, resulting in inconsistent printing height. Reference numeral 300 is a plate to be printed, reference numeral 400 is a printing station, and reference numeral 500 is a screen frame.

The present disclosure provides a screen printing device as shown in FIG. 2. The screen printing device comprises a transport mechanism 1. The transport mechanism 1 is used to carry and transport a plate to be printed 11 disposed on the transport mechanism. The screen printing device further comprises a rotating frame 2 located above the transport mechanism 1. The rotating frame 2 is used for winding a screen 21 and driving the screen 21 rotation. The screen printing device further comprises a glue container 4 located in the rotating frame 2 and disposed to be independent of the rotating frame 2 (i.e. the glue container 4 is not mounted on the rotating frame 2, and there is no relevant matching structure between the glue container 4 and the rotating frame 2; when the rotating frame 2 rotates, the glue container 4 does not rotate together with the rotating frame 2). A lower portion of the glue container 4 is provided with a glue outlet 62 and a scraper 61, and the scraper 61 is located beside the glue outlet 62.

In the screen printing device provided by the present disclosure during printing process, the screen 21 is wound on the rotating frame 2, the plate to be printed 11 is placed on the transport mechanism 1, and the encapsulant 7 is placed in the glue container 4. When printing the plate to be printed 11, the glue outlet 62 is above the plate to be printed 11 and the encapsulant is discharged toward the plate to be printed 11. As the rotating frame 2 drives the screen 21 to rotate, the scraper 61 squeezes the encapsulant 7 to print the encapsulant 7 on the plate to be printed 11. This technical solution adopts a rolling printing mode. When each position of the screen 21 is rotated to the scraper 61 at the time of printing, the tension generated by each position of the screen 21 at the scraper 61 is the same, thereby avoiding the poor printing uniformity due to the tension difference during the printing process, and also avoiding the problems that the screen is not left in time and the screen is stuck due to aging of the screen.

Optionally, the screen printing device further comprises a first driving mechanism (not shown). The first driving mechanism is coupled to the rotating frame 2 for driving the rotating frame 2 to rotate. The screen printing device further comprises a control system electrically connected to the transport mechanism 1 and the first driving mechanism. According to a printing parameter of the plate to be printed 11, a transport speed of the plate to be printed 11 is adjusted by the transport mechanism 1, and a rotation speed of the rotating frame is adjusted by the first driving mechanism. Therefore, the screen printing device of the present embodiment can realize a continuous printing and improve production efficiency.

Optionally, the screen printing device further comprises a pressure supply mechanism (not shown). The pressure supply mechanism is connected to the glue container 4 for supplying pressure to the glue container 4, so as to adjust an amount of glue discharged from the glue outlet 62. The glue container 4 forms a closed space, and the encapsulant 7 is contained in the glue container 4. In FIG. 2, reference “a” represents a supply pressure. The control system is further electrically connected to the pressure supply mechanism. The control system is configured to adjust the pressure in the glue container 4 by the pressure supply mechanism according to the printing parameter of the plate to be printed 11.

The pressure supply mechanism is connected to the glue container 4, and the encapsulant 7 is placed in the glue container 4. The glue container 4 forms a closed space, which is not in communication with the outside, thereby preventing inconsistent printing height at each printing position due to volatilization of the solvent in the encapsulant 7 with time. Furthermore, the pressure in the glue container is controlled by the pressure supply mechanism, so as to ensure that the encapsulant can smoothly flow out through the glue outlet 62. At the same time, the amount of the glue discharged from the glue outlet 62 can be effectively controlled, and the inconsistent printing height due to an inconsistent glue output can be avoided.

Optionally, the screen printing device further comprises a second driving mechanism (not shown). The second driving mechanism is independent of the rotating frame 2 (i.e. the second driving mechanism is not mounted on the rotating frame 2, and there is no relevant matching structure between the second driving mechanism and the rotating frame 2; when the rotating frame 2 rotates, the second driving mechanism does not rotate together with the rotating frame 2). The glue container 4 is mounted on the second driving mechanism. The second driving mechanism is configured to drive the glue container 4 to move and/or rotate. The control system is further electrically connected to the second driving mechanism. The control system is configured to adjust a position of the glue container 4 within the rotating frame 2 by the second driving mechanism according to the printing parameter of a plate to be printed 11, so as to adjust a position of the scraper 61 within the rotating frame 2.

The control system is configured to adjust a position of the glue container 4 within the rotating frame 2 by the second driving mechanism according to the printing parameter of a plate to be printed 11, so as to adjust a position of the scraper 61 within the rotating frame 2. The transport mechanism 1, first driving mechanism, pressure supply mechanism and second driving mechanism cooperate with each other. Therefore, the printing height and uniformity are good, and there is no problem of the screen being stuck, which improves the printing quality.

Particularly, the second driving mechanism comprises a moving member and a rotating member (not shown). The rotating member is mounted on the moving member, and the glue container is mounted on the rotating member. The moving member is configured to drive the rotating member and the glue container to achieve a six-direction movement. The rotating member is configured to drive the glue container to rotate. Therefore, the position of the glue container can be adjusted to ensure the printing quality of the product. The second driving mechanism drives the glue container to move in six directions (i.e. up, down, left, right, front and rear) and to rotate, thereby adjusting the position and the angle.

Definitely, the second driving mechanism may also comprise only a member for example the moving member or the rotating member, etc. Even the range of position adjustment may be reduced, the purpose of the present application can also be achieved and the purpose thereof is not deviated from the design idea of the present disclosure. It will not be described in detail here, and it should be within the scope of protection of the present application.

Furthermore, the screen printing device further comprises a cover plate 5 disposed in the glue container 4. A periphery of the cover plate 5 is sealingly engaged with an inner side surface of the glue container 4. However, it should be understood that the cover plate 5 can slide within the glue container 4. The pressure supplied into the glue container 4 by the pressure supply mechanism acts on an upper surface of cover plate 5, so as to discharge the glue (i.e., the encapsulant 7) from the glue outlet 62 to ensure an accurate glue output. The screen printing device of the present embodiment can prevent the following situation: the pressure directly acts on a surface of the encapsulant 7 to make the encapsulant 7 roll and surge, which is harmful to evenly and continuously discharging the glue, and the difficulty of controlling the glue output will increase.

Furthermore, the screen printing device further comprises a sealing ring (not shown). The sealing ring is located between the inner side surface of the glue container 4 and the cover plate 5, and is fixed on the cover plate 5. The gap between the inner side surface of the glue container 4 and the cover plate 5 is sealed, so as to prevent overflowing of the glue. Optionally, an inner cavity of the glue container 4 is a cuboid, and the cover plate 5 has a rectangular plate shape. The cross section area of the inner cavity of the glue container 4 is uniform in a vertical direction, so as to ensure that the cover plate 5 can continuously perform the function of pressing and sealing during a vertical movement.

Specifically, the periphery of the cover plate 5 is provided with an annular mounting groove. The sealing ring is pressed into the mounting groove through the inner side surface of the glue container 4, and the mounting groove prevents the sealing ring from coming out. Optionally, a rotation direction of the rotating frame 2 is different from a direction of a transport speed of the transport mechanism 1 at a position of the scraper 61 during printing process. For example, when the rotating frame 2 is rotated in the counterclockwise direction, the transport speed of the transport mechanism is from right to left; and when the rotating frame 2 is rotated clockwise (as indicated by arrow b in FIG. 2), the transport speed of the transport mechanism is from left to right (as indicated by arrow c in FIG. 2). Since the rotation direction of the rotating frame is different from the direction of the transport speed of the transport mechanism at the position of the scraper, the relative speed at the scraper between the screen and the plate to be printed is large, so as to easier realize the relative separation between the screen and the plate to be printed. Therefore, the problems that the screen is not left in time and the screen is stuck and the like are prevented.

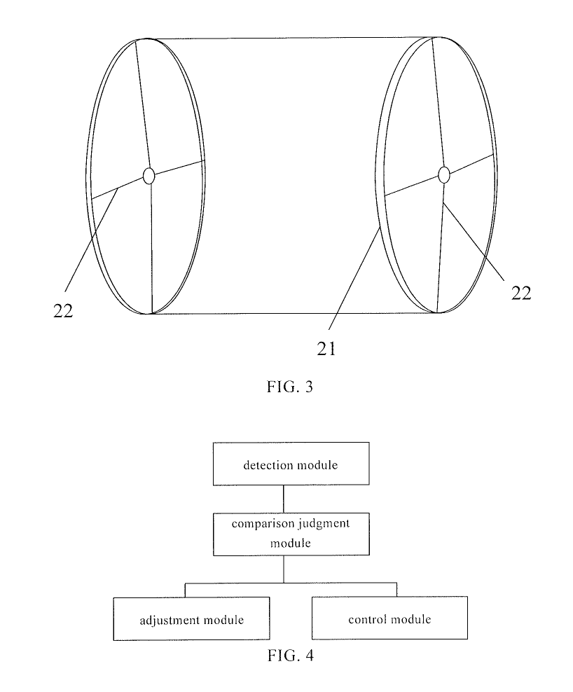

Optionally, as shown in FIG. 3, the rotating frame 2 comprises two rotating disks 22 which are symmetrically disposed. The screen 21 is disposed between the two rotating disks 22. A pair of opposite sides of the screen 21 is wound on the two rotating disks 22, and the first driving mechanism drives the two rotating disks 22 to rotate synchronously. The encapsulant 7 pressed out from the glue outlet 62 falls onto the screen 21.

Furthermore, another pair of opposite sides of the screen 21 is aligned to form a cylindrical shape. The plate to be printed 11 is a glass plate, which is capable of better continuous printing, and prevents problems such as leakage of glue at the position where another pair of opposite sides of the screen 21 is aligned during printing process.

Optionally, the control system comprises a detection module. The detection module is used to detect the transport speed of the transport mechanism and the rotation speed of the rotating frame constantly. The control system further comprises a controller electrically connected to the detection module. The controller is configured to adjust the transport speed of the transport mechanism according to a transport speed data corresponding to the printing parameter of the plate to be printed. The controller is also configured to adjust the rotation speed of the rotating frame according to a rotation speed data corresponding to the printing parameter of the plate to be printed.

Before the printing, the controller adjusts the position of the glue container within the rotating frame through the second driving mechanism. The tension between the scrape and the screen is required to meet the printing requirement for non-sticking. The controller can also monitor the position of the scrape during printing process.

Particularly, as shown in FIG. 4, the controller comprises a comparison judgment module (for example, a comparison judgment circuit) electrically connected to the detection module. The comparison judgment module is used to compare the transport speed being detected with the transport speed data corresponding to the printing parameter of the plate to be printed, and then send a transport speed failure information if a comparison result is unqualified. The comparison judgment module is also used to compare the pressure being detected with a pressure data corresponding to the printing parameter of the plate to be printed, and then send a pressure failure information if the comparison result is unqualified. Further, the comparison judgment module is also used to compare the rotation speed being detected with the rotation speed data corresponding to the printing parameter of the plate to be printed, and then send a rotation speed failure information if the comparison result is unqualified. The controller further comprises an adjustment module (for example, a adjustment circuit) electrically connected to the comparison judgment module. The adjustment module is used to adjust the transport speed of the transport mechanism to a value of the transport speed data when receiving the transport speed failure information. The adjustment module is also used to adjust the pressure of the pressure supply mechanism to a value of the pressure data when receiving the pressure failure information. The adjustment module is also and used to adjust the rotation speed of the rotating frame to a value of the rotation speed data by the first driving mechanism when receiving the rotation speed failure information.

For example, the comparison judgment module may be configured to detect whether a difference between the transport speed and the transport speed data falls within a corresponding reference range. If it falls within the reference range, it is determined that the comparison result is qualified and rotation speed qualification information is sent. If the comparison result is out of the reference range, it is determined that the comparison result is unqualified and the rotation speed failure information is sent. The difference is converted into an adjustment amount for the adjustment module to adjust the transport mechanism. The judgement methods with respect to the pressure and the rotation speed are similar to that of the transport speed, which will not be described in detail herein.

As shown in FIG. 4, the controller further comprises a control module (for example, a control circuit) electrically connected to the comparison judgment module. The control module is used to control the transport mechanism, so as to keep the transport speed when receiving a transport speed qualification information. The control module is also used to control the pressure supply mechanism, so as to keep the pressure when receiving a pressure qualification information. The control module is also used to control the first driving mechanism to drive the rotating frame, so as to keep the rotation speed when receiving a rotation speed qualification information.

The control system performs control constantly, which can further improve a control precision of the transport mechanism, the first driving mechanism, the pressure supply mechanism and the second driving mechanism. As a result, the printing quality of the product can be better.

Definitely, the screen printing device provided by the present disclosure can also print other printing materials equivalent to the encapsulant, and details are not described herein.

Accordingly, in the screen printing device provided by the present disclosure, the screen is wound and mounted on the rotating frame during printing process, the plate to be printed is placed on the transport mechanism, and the encapsulant is placed in the glue container. The glue outlet is located above the plate to be printed during printing process. The encapsulant is discharged toward the plate to be printed. As the rotating frame drives the screen to rotate, the scraper squeezes the glue out and prints on the plate to be printed. This technical solution adopts a rolling printing mode. When each position of the screen is rotated to the scraper at the time of printing, the tension generated by each position of the screen at the scraper is the same, thereby avoiding the poor printing uniformity due to the tension difference during the printing process, and also avoiding the problems occurred in the conventional arts that the screen is not left in time and the screen is stuck due to aging of the screen.

In the description herein, the terms “mount”, “connect”, “fix”, etc., should be understood broadly. For example, “connect” may be a fixed connection, a detachable connection, or an integral connection. They can be directly connected or indirectly connected through an intermediate medium. For those of ordinary skilled in the art, the specific meanings of the above terms herein may be understood according to a specific situation.

In the description of the present specification, the description of the terms “one embodiment”, “an embodiment”, “the embodiment”, or the like, is intended to mean that the specific features, configurations, materials, or characteristics described in connection with the embodiments or examples are included in at least one embodiment or example. In the present specification, the schematic expression of the above terms does not necessarily refer to the same embodiment or example. Furthermore, the particular features, configurations, materials, or characteristics may be combined in a suitable manner in any one or more embodiments or examples.

Although the embodiments disclosed herein are as above, the description is only for the purpose of understanding the embodiments herein, and is not intended to limit the present application. Any modification or variation in formal and details of the implementation may be made by those skilled in the art without departing from the spirit and scope of the disclosure. The protection scope of the present application is defined by the appended claims.

1. A screen printing device, comprising:
a transport mechanism, which is used to carry and transport a plate to be printed disposed on the transport mechanism;
a rotating frame located above the transport mechanism, which is used for winding a screen and driving the screen rotation; and
a glue container located in the rotating frame and disposed to be independent of the rotating frame, wherein a lower portion of the glue container is provided with a glue outlet and a scraper, and the scraper is located beside the glue outlet.

2. The screen printing device according to claim 1, further comprising:
a first driving mechanism coupled to the rotating frame, which is used for driving the rotating frame to rotate;
a control system electrically connected to the transport mechanism and the first driving mechanism,
wherein, according to a printing parameter of the plate to be printed, a transport speed of the plate to be printed is adjusted by the transport mechanism, and a rotation speed of the rotating frame is adjusted by the first driving mechanism.

3. The screen printing device according to claim 2, further comprising:
a pressure supply mechanism connected to the glue container, which is used for supplying pressure to the glue container, so as to adjust an amount of glue discharged from the glue outlet;
wherein the control system is further electrically connected to the pressure supply mechanism, and the control system is configured to adjust the pressure in the glue container by the pressure supply mechanism according to the printing parameter of the plate to be printed.

4. The screen printing device according to claim 1, further comprising:
a second driving mechanism, which is independent of the rotating frame, wherein the glue container is mounted on the second driving mechanism, and the second driving mechanism is configured to drive the glue container to move or rotate;
wherein the control system is further electrically connected to the second driving mechanism, the control system is configured to adjust a position of the glue container within the rotating frame by the second driving mechanism according to the printing parameter of a plate to be printed, so as to adjust a position of the scraper within the rotating frame.

5. The screen printing device according to claim 1, further comprising:
a second driving mechanism, which is independent of the rotating frame, wherein the glue container is mounted on the second driving mechanism, and the second driving mechanism is configured to drive the glue container to move and rotate;
wherein the control system is further electrically connected to the second driving mechanism, the control system is configured to adjust a position of the glue container within the rotating frame by the second driving mechanism according to the printing parameter of a plate to be printed, so as to adjust a position of the scraper within the rotating frame.

6. The screen printing device according to claim 5, wherein the second driving mechanism comprises a moving member and a rotating member, the rotating member is mounted on the moving member, and the glue container is mounted on the rotating member, the moving member is configured to drive the rotating member and the glue container to achieve a six-direction movement, and the rotating member is configured to drive the glue container to rotate.

7. The screen printing device according to claim 3, further comprising:
a cover plate disposed in the glue container, wherein a periphery of the cover plate is sealingly engaged with an inner side surface of the glue container, and the pressure supplied into the glue container by the pressure supply mechanism acts on an upper surface of cover plate.

8. The screen printing device according to claim 7, further comprising:
a sealing ring located between the inner side surface of the glue container and the cover plate, wherein the sealing ring is fixed on the cover plate.

9. The screen printing device according to claim 7, wherein an inner cavity of the glue container is a cuboid, and the cover plate has a rectangular plate shape.

10. The screen printing device according to claim 1, wherein a rotation direction of the rotating frame is different from a direction of a transport speed of the transport mechanism at a position of the scraper during printing process.

11. The screen printing device according to claim 2, wherein the rotating frame comprises two rotating disks which are symmetrically disposed, the screen is disposed between the two rotating disks, a pair of opposite sides of the screen is wound on the two rotating disks, and the first driving mechanism drives the two rotating disks to rotate synchronously.

12. The screen printing device according to claim 11, wherein another pair of opposite sides of the screen is aligned to form a cylindrical shape.

13. The screen printing device according to claim 2, wherein the control system comprises:
a detection module, which is used to detect the transport speed of the transport mechanism and the rotation speed of the rotating frame constantly; and
a controller electrically connected to the detection module, which is configured to adjust the transport speed of the transport mechanism according to a transport speed data corresponding to the printing parameter of the plate to be printed, and adjust the rotation speed of the rotating frame according to a rotation speed data corresponding to the printing parameter of the plate to be printed.

14. The screen printing device according to claim 13, wherein the controller comprises:
a comparison judgment module electrically connected to the detection module, which is used to compare the transport speed being detected with the transport speed data corresponding to the printing parameter of the plate to be printed and send a transport speed failure information if a comparison result is unqualified; and also used to compare the rotation speed being detected with the rotation speed data corresponding to the printing parameter of the plate to be printed and send a rotation speed failure information if the comparison result is unqualified; and
an adjustment module electrically connected to the comparison judgment module, which is used to adjust the transport speed of the transport mechanism to a value of the transport speed data when receiving the transport speed failure information, and used to adjust the rotation speed of the rotating frame to a value of the rotation speed data by the first driving mechanism when receiving the rotation speed failure information.

15. The screen printing device according to claim 14, wherein the controller further comprises:
a control module electrically connected to the comparison judgment module, which is used to control the transport mechanism to keep the transport speed when receiving a transport speed qualification information, and used to control the pressure supply mechanism to keep the pressure when receiving a pressure qualification information, and used to control the first driving mechanism to drive the rotating frame to keep the rotation speed when receiving a rotation speed qualification information.
